(19) United States
(12) Patent Application Publication
(10) Pub. No.: US 2007/0243423 A1
(43) Pub. Date: Oct. 18, 2007

(54) Non-directional connection module

(76) Inventor: Chin-Hsin Ho, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/635,594

(22) Filed: Dec. 8, 2006

(30) Foreign Application Priority Data
Apr. 14, 2006 (TW) 95113500

(51) Int. Cl. H01M 2/34; H01M 2/10; H01R 27/00

(52) U.S. Cl. 429/1; 429/121; 429/100; 439/217

(57) ABSTRACT

A non-directional connection module is described for connecting with a battery. The non-directional connection module uses a first conductive element to connect the positive pole of the battery, and a second conductive element to connect the negative pole of the battery. An insulation element is positioned between the first conductive element and the second conductive element. Both the second conductive element and the insulation element have respective holes. The positive pole of the battery can pass through the holes, but the negative pole of the battery cannot pass through the holes. In this light, the present invention uses the non-directional connection module to connect the battery so that there is no consideration of the positive or negative poles of the battery.

### BACKGROUND OF THE INVENTION

1. Field of the Invention

The present invention relates to a non-directional connection module, and in particular, to a connection module for connecting a battery without considering positive and negative poles of the battery.

2. Description of Related Art

Various portable electronic appliances or products which need low power consumption are in use, these electronic appliances or product such as flash lights, camera, portable audio players, portable stereo speakers or remote control are powered by batteries. Generally, these electronic appliances are powered by several batteries in series, and negative pole of one battery must be connected positive pole of other battery. These batteries are connected in a fashion: + to − to + to − etc. FIG. 1 illustrates how batteries are installed in an electronic device 9 in prior art. When batteries 4 are installed within a conventional electronic device 9, user should pay attention to poles of the batteries 4. According to pole marks 91 of battery chamber 92, the batteries 4 can correctly be installed so that the batteries 4 function to power the electronic device 9. If pole arrangement of the batteries 4 does not coincide with the pole marks 91 of the electronic device 9, then the batteries 4 cannot supply power because a plastic protrusion 93 is positioned at cover of the battery chamber 92. However, the pole arrangement of the batteries 4 does not coincide with the pole marks 91 of the electronic device 9 because of users' inadvertent operation or worse design of the electronic device 9. Thus, the electronic device may be broken by misalignment of the batteries 4 so it has adverse impact on users.

In general, the batteries are installed in accordance with the poles marks of the electronic devices because of security. However, it is inconvenient for users to install the batteries and recognize the pole marks simultaneously. For example, users need to install the batteries into battery chamber in weak ambient light, and it is difficult for users to recognize the pole marks and install the batteries. Even worse, if users need to install the batteries in emergency and need to recognize the pole marks, it is impossible for users to use the electronic device timely. In addition, when the batteries installed into the battery chamber do not coincide with the pole marks and do not supply electric power, these error messages are not available to users.

Thus, there is a need for a non-directional connection module.

### SUMMARY OF THE INVENTION

It is an object of the present invention to provide a non-directional connection module that is used to electrically connect positive and negative poles of batteries. A plurality of non-directional connection modules are positioned within battery chamber to connect the batteries. Thus, it is not necessary for users to consider poles of the batteries when users need to install batteries.

To achieve the object of the present invention, it provides a non-directional connection module including a first connective element, a second conductive element and an insulation element. The first conductive element is used to connect the positive pole of the battery, and the second conductive element is used to connect the negative pole of the battery and has a hole. The positive pole of the battery passes through the hole of the second conductive element. The insulation element is positioned between the first conductive element and the second conductive element. Both the second conductive element and the insulation element have respective holes. The positive pole of the battery can pass through these holes.

The present invention provides a non-directional connector for connecting a battery. The present invention includes a first conductive element, a second conductive element, a third conductive element, a fourth conductive element, a first insulation element and a second insulation element. The first conductive element and the third conductive element are used to connect the positive poles of the battery, and the first conductive element is electrically connected with the third conductive element. The second conductive element and the fourth conductive element are used to connect the negative poles of the battery, and the second conductive element is electrically connected with the fourth conductive element. The second conductive element and the fourth element have a first hole and a third hole respectively so that the positive poles of the batteries can pass through the first and the third holes. The first insulation element is positioned between the first conductive element and the second conductive element and has a second hole so that positive poles of the batteries can pass through the second hole. The second insulation element is positioned between the third conductive element and the fourth conductive element and has a fourth hole so that positive poles of the batteries can pass through the fourth hole.

It is another object of the present invention to provide a non-directional connection device that is used to connect a plurality of batteries. A first non-directional connector connects a first battery, and a second non-directional connector connects a second battery and electrically connects the first non-directional connector. The first non-directional connector employs the first non-directional connection module and the second non-directional connection module to connect positive or negative pole of the first battery. The second non-directional connection module electrically connects the first non-directional connection module. The second non-directional connector utilizes a third non-directional connection module and a fourth non-directional connection module to connect positive or negative pole of the second battery. The fourth non-directional connection module electrically connects the third non-directional connection module.

As mentioned above, users can easily and quickly install batteries without considering poles of the batteries in emergency or in weak ambient light.

### BRIEF DESCRIPTION OF THE DRAWINGS

The present invention can be fully understood from the following detailed description and preferred embodiment with reference to the accompanying drawings, in which:

FIG. 1 is a schematic of showing how batteries are installed into battery chamber in the prior art;

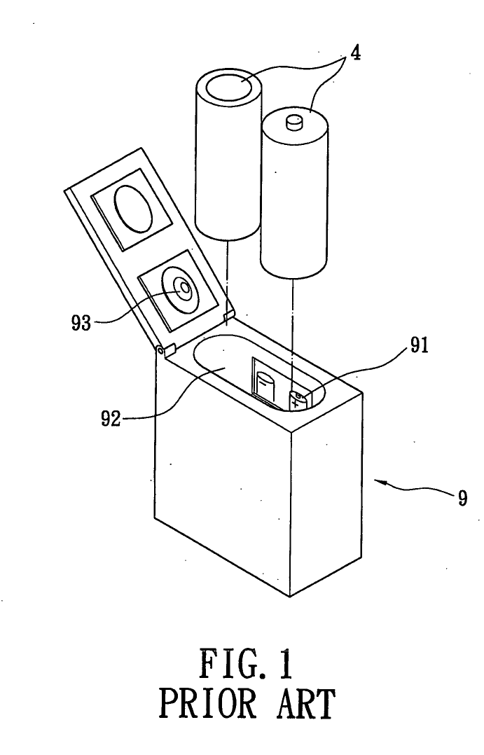

FIG. 2A is an exploded view of a non-directional connection module according to the first embodiment of the present invention;

FIG. 2B is a cross-sectional view of a non-directional connection module according to the first embodiment of the present invention;

FIG. 3A is an exploded view of a non-directional connection module according to the second embodiment of the present invention;

FIG. 3B is a cross-sectional view of a non-directional connection module according to the second embodiment of the present invention;

FIG. 4 is an exploded view of a non-directional connection module according to the third embodiment of the present invention;

FIG. 4A is a cross-sectional view of a non-directional connector according to the first embodiment of the present invention;

FIG. 4B is a cross-sectional view of a non-directional connector according to the second embodiment of the present invention; and

FIG. 5 is an exploded view of a non-directional connection module according to the fourth embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

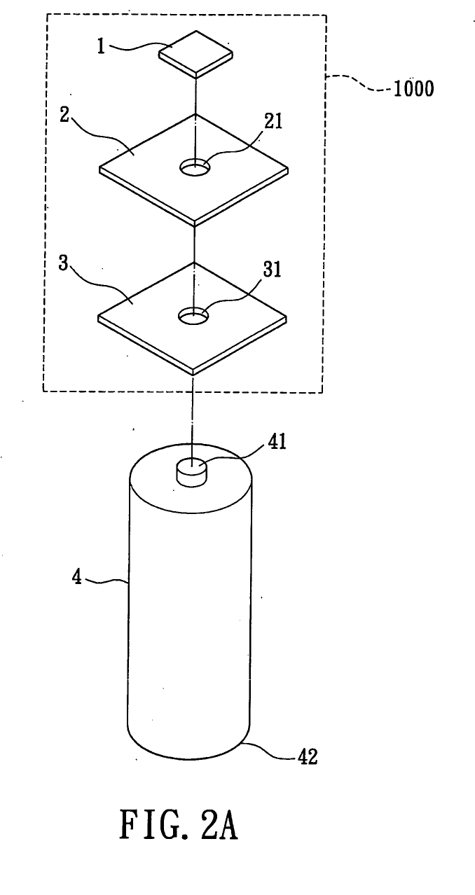

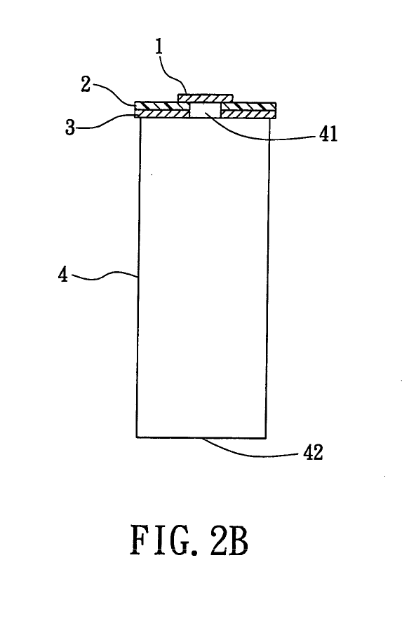

Reference is made to FIG. 2A. FIG. 2A illustrates an exploded view of a non-directional connection module according to the first embodiment of the present invention. FIG. 2A shows interconnection between a non-directional connection module 1000 and a battery 4 of the present invention. The non-directional connection module 1000 includes a first conductive element 1, a second conductive element 3 and a first insulation element 2. The first conductive element 1 is used to connect a positive pole 41 of the battery 4, and the second conductive element 3 is used to connect a negative pole 42 of the battery 4 has a first hole 31. The first insulation element 2 has a second hole 21 and is positioned between the first conductive element 1 and the second conductive element 3 to insulate the first conductive element 1 and the second conductive element 3. In addition, the first insulation element 2 can be made of plastic. The positive pole 41 of the battery 4 can pass through the first hole 31 and the second hole 21 to be in contact with the first conductive element 1. FIG. 2B illustrates a cross-sectional view of a non-directional connection module 1000 according to the first embodiment of the present invention. The non-directional connection module 1000 is in contact with the positive pole 41 of the battery 4. As shown in FIG. 2B, the positive pole 41 of the battery 4 passes through the first hole 31 of the second conductive element 3 and the second hole 21 of the first insulation element 2 to be in contact with the first conductive element 1. The first hole 31 and the second hole 21 are adapted to receive the positive pole 41 of the battery 4, and however, the negative pole 42 of the battery 4 cannot pass through the first hole 31 and the second hole 21. That is, the size of the first hole 31 and the second hole 21 is larger than that of the positive pole 41 of the battery 4 and is smaller than that of the negative pole 42 of the battery 4.

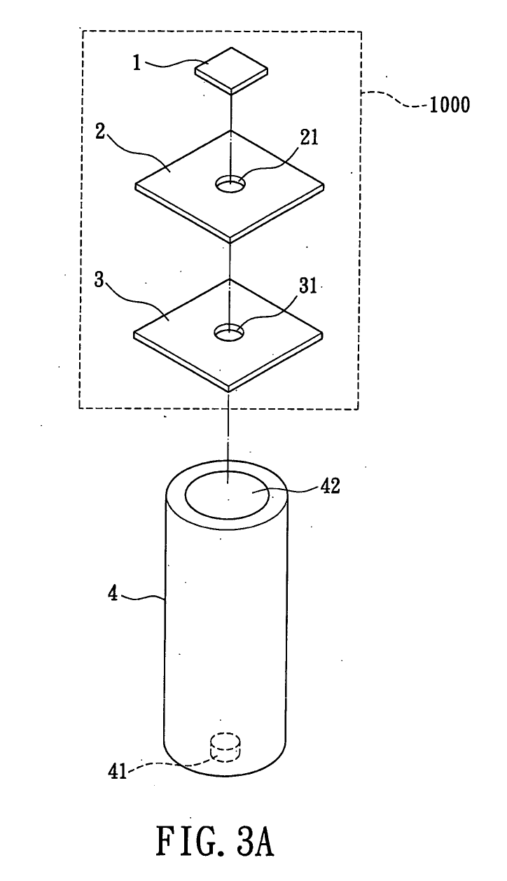

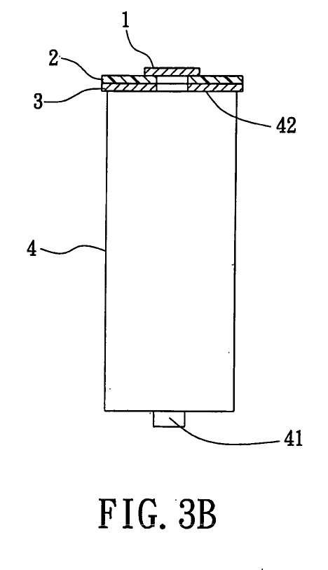

FIG. 3A illustrates an exploded view of a non-directional connection module according to the second embodiment of the present invention. As shown in FIG. 3A, the non-directional connection module 1000 includes a first conductive element 1, a second conductive element 3 and a first insulation element 2. The first conductive element 1 is used to connect a positive pole 41 of the battery 4, and the second conductive element 3 is used to connect a negative pole 42 of the battery 4 has a first hole 31. The first insulation element 2 has a second hole 21 and is positioned between the first conductive element 1 and the second conductive element 3 to insulate the first conductive element 1 and the second conductive element 3. In addition, the first insulation element 2 can be made of plastic, and the negative pole 42 of the battery 4 cannot pass through the first hole 31 and the second hole 21 to prevent the negative pole 42 from contacting the first conductive element 1. FIG. 3B illustrates a cross-sectional view of a non-directional connection module according to the second embodiment of the present invention. When the negative pole 42 of the battery 4 is in contact with the non-directional connection module 1000, the negative pole 42 of the battery 4 is merely in contact with the second conductive element 3 and cannot pass through the first hole 31 and the second hole 21 and is in contact with the first conductive element 1. The first hole 31 and the second hole 21 are adapted to receive the positive pole 41 of the battery 4, and however, the negative pole 42 of the battery 4 cannot pass through the first hole 31 and the second hole 21. That is, the size of the h first hole 31 and the second hole 21 is larger than that of the positive pole 41 of the battery 4 and is smaller than that of the negative pole 42 of the battery 4.

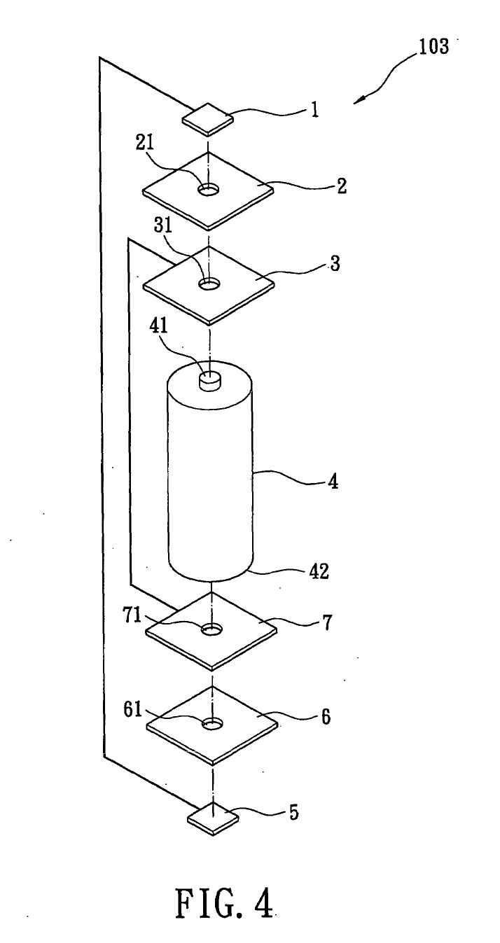

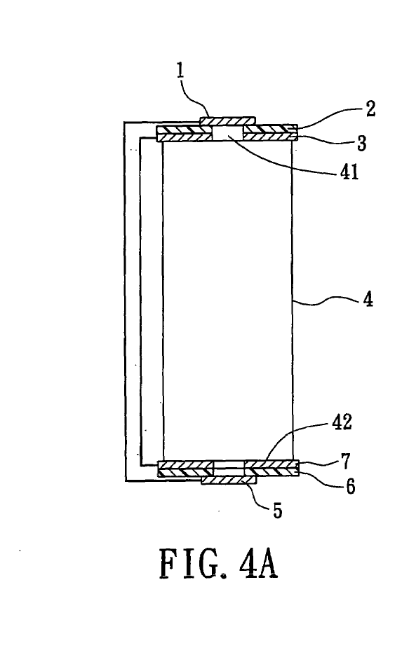

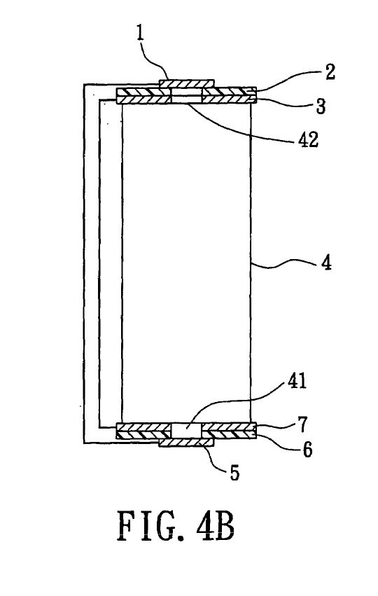

Reference is made to FIG. 4. FIG. 4 illustrates an exploded view of a non-directional connection module according to the third embodiment of the present invention. As shown in FIG. 4, a non-directional connector 103 is applied at battery chambers of various electronic appliances. Thus, batteries are installed into the battery chambers without considering positive or negative pole of the batteries. The non-directional connector 103 includes a first conductive element 1, a second conductive element 3 and a first insulation element 2, a third conductive element 5, a fourth conductive element 7 and a second insulation element 6. The first conductive element 1 electrically connects the third conductive element 5, and both the first conductive element 1 and the third conductive element 5 are used to connect a positive pole 41 of the battery 4. The second conductive element 3 electrically connects the fourth conductive element 7, and both the second conductive element 3 and the fourth conductive element 7 are used to connect a negative pole 42 of the battery 4. The second conductive element 3 also has a first hole 31, and the fourth conductive element 7 also has a third hole 21. The first insulation element 2 is positioned between the first conductive element 1 and the second conductive element 3 so as to insulate the first conductive element 1 and the second conductive element 3. In addition, the first insulation element 2 has a second hole 21. The second insulation element 6 is positioned between the third conductive element 5 and the fourth conductive element 7 so as to insulate the third conductive element 5 and the fourth conductive element 7. Besides, the second insulation element 6 has a fourth hole 61. The sizes of the holes 31, 71, 21 and 61 are larger than those of the positive pole 41 of the battery 4 and are smaller than those of the negative pole 42 of the battery 4. In this light, the positive pole 41 of the battery 4 may be in contact with the first conductive element 1 or the third conductive element 5, and the negative pole 42 of the battery 4 is not in contact with the first conductive element 1 and the third conductive element 5. Besides, the negative pole 42 of the battery 4 is merely in contact with the second conductive element 3 and the fourth conductive element 7.

According to the present invention, the non-directional connector 103 is used to install the battery 4 into the battery chamber without considering the positive or negative poles of the batteries. Thus, the first conductive element 1 or the third conductive element 5 is used to supply positive electric charges, and the second conductive element 3 and the fourth conductive element 7 are used to supply negative electric charges. As shown in FIG. 4A, it shows a cross-sectional view of a non-directional connector according to the first embodiment of the present invention. The positive pole 41 of the battery 4 may be in contact with the first conductive element 1, and the negative pole 42 of the battery 4 is in contact with the fourth conductive element 7. Besides, the first conductive element 1 or the third conductive element 5 is used to supply positive electric charges, and the second conductive element 3 or the fourth conductive element 7 is used to supply negative electric charges. Further, as shown in FIG. 4B, it illustrates a cross-sectional view of a non-directional connector according to the second embodiment of the present invention. The positive pole 41 of the battery 4 may be in contact with the third conductive element 5, and the negative pole 42 of the battery 4 is in contact with the second conductive element 3. Besides, the first conductive element 1 or the third conductive element 5 is used to supply positive electric charges, and the second conductive element 3 and the fourth conductive element 7 are used to supply negative electric charges.

As mentioned above, the first conductive element 1 is connected with the third conductive element 5 and the second conductive element 3 is connected with the fourth conductive element 7 by a conductive wire or a metallic material. Both the first insulation element 2 and the second insulation element 6 can be made of plastic.

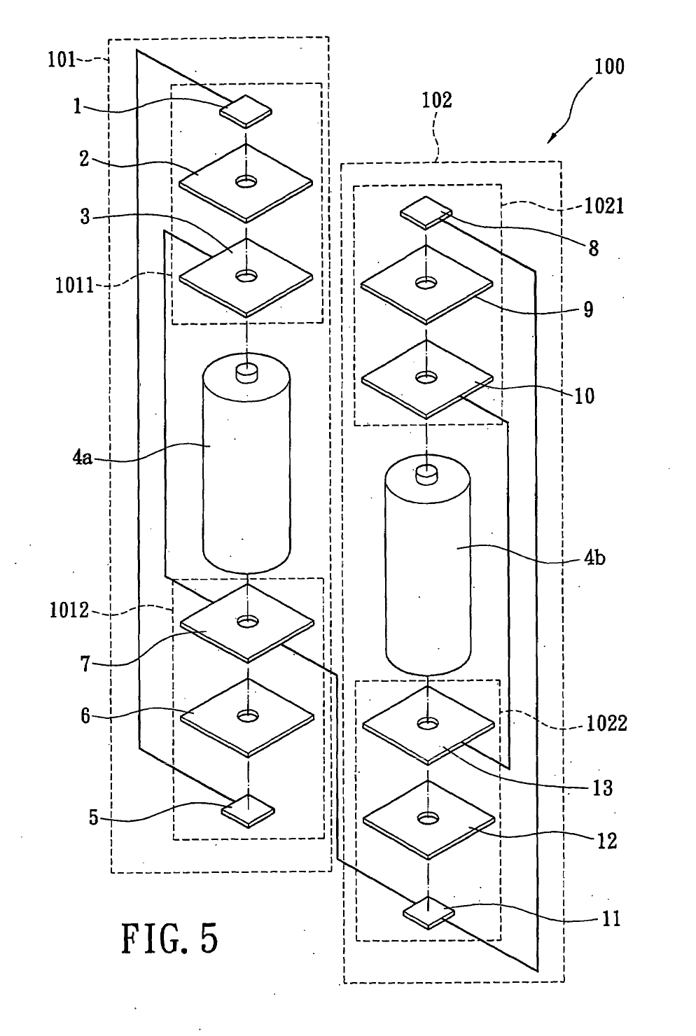

Reference is made to FIG. 5. FIG. 5 illustrates an exploded view of a non-directional connection module according to the fourth embodiment of the present invention. The non-directional connection device 100 is used to connect a plurality of batteries. The non-directional connection device 100 includes a first non-directional connection connector 101 and a second non-directional connection connector 102. The first non-directional connection connector 101 is used to connect a first battery 4a and has a first non-directional connection module 1011 and a second non-directional connection module 1012. The second non-directional connection connector 102 electrically connects the first non-directional connection connector 101 and used to connect a second battery 4b. The second non-directional connection connector 102 includes a third non-directional connection module 1021 and a fourth non-directional connection module 1022. The first non-directional connection module 1011 includes the first conductive element 1, the second conductive element 3 and the first insulation element2. The second non-directional connection module 1012 includes the third conductive element 5, the fourth conductive element 7 and the second insulation element 6. The third non-directional connection module 1021 includes the fifth conductive element 8, the sixth conductive element 10 and the third insulation element 9. The fourth non-directional connection module 1022 includes the seventh conductive element 11, the eighth conductive element 13 and the fourth insulation element 12.

The first non-directional connection connector 101 connects the first battery 4a by the first non-directional connection module 1011 and the second non-directional connection module 1012. The second non-directional connection connector 102 connects the second battery 4b by the third non-directional connection module 1021 and the fourth non-directional connection module 1022. As mentioned above, FIG. 4 shows the third embodiment of the non-directional connector to explain how the first non-directional connection connector 101 and the second non-directional connection connector 102 operate in the present invention. Detailed description of the non-directional connection device 100 will be omitted. The first non-directional connection connector 101 and the second non-directional connection connector 102 are used to install the first battery 4a and the second battery 4b without considering positive or negative poles of the first battery 4a and the second battery 4b. The first conductive element 1, the third conductive element 5, the fifth conductive element 8 and the seventh conductive element 11 are used supply positive electric charges, and the second conductive element 3, the fourth conductive element 7, the sixth conductive element 10 and the eighth conductive element 13 are used to supply negative electric charges. Interconnection between the first non-directional connection connector 101 and the second non-directional connection connector 102 is detailed in the following.

As described above, the first non-directional connection connector 101 is connected with the second non-directional connection connector 102 by connecting the first conductive element 1 with the sixth conductive element 10 or the eighth conductive element 13 or by connecting the third conductive element 5 with the sixth conductive element 10 or the eighth conductive element 13. In this light, a close circuit is formed. Alternately, the fifth conductive element 8 is connected with the second conductive element 3 or the fourth conductive element 7, or the seventh conductive element 11 is connected with the second conductive element 3 or the fourth conductive element 7 so that a closed circuit is formed. The first battery 4a and the second battery 4b are connected by the first non-directional connection connector 101 and the second non-directional connection connector 102 (without considering positive or negative poles of batteries). Thus, the first battery 4a is connected with the second battery 4b in series so as to supply electric power. A third non-directional connector or the fourth non-directional connector is utilized to achieve object of the present invention.

In summary, according to the present invention, batteries are installed into battery chambers of electronic devices without considering positive or negative poles of batteries so that batteries can supply electric power. Thus, it is simple, fast and convenient for users to install batteries even in weak light ambient or in emergency.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A non-directional connection module, comprising:
a first connective element, used to connect a positive pole of a battery;
a second conductive element, used to connect a negative pole of the battery and having a first hole so that the positive pole of the battery passes through the first hole; and
an insulation element, positioned between the first conductive element and the second conductive element, and having a second hole so that the positive pole of the battery passes through the second hole.

2. The non-directional connection module as claimed in claim 1, wherein the insulation element is made of plastic.

3. The non-directional connection module as claimed in claim 1, wherein the sizes of the holes are larger than those of the positive pole of the battery and are smaller than those of the negative pole of the battery.

4. A non-directional connector used to connect a battery, comprising:
a first connective element, used to connect a positive pole of the battery;
a second conductive element, used to connect a negative pole of the battery and having a first hole so that the positive pole of the battery passes through the first hole;
an first insulation element, positioned between the first conductive element and the second conductive element, and having a second hole so that the positive pole of the battery passes through the second;
a third conductive element, used to connect the positive pole of the battery and electrically connect the first conductive element;
a fourth conductive element, used to connect the negative pole of the battery and electrically connect the second conductive element and having a third hole so that the positive pole of the battery passes through the third hole; and
an second insulation element, positioned between the third conductive element and the fourth conductive element and having a fourth hole so that the positive pole of the battery passes through the fourth hole.

5. The non-directional connector as claimed in claim 4, wherein the first conductive element or the third conductive element is used to supply positive electric charges and the second conductive element or the fourth conductive element is used to supply negative electric charges when the non-directional connector connects the battery.

6. The non-directional connector as claimed in claim 4, wherein the first insulation element is made of plastic.

7. The non-directional connector as claimed in claim 4, wherein the second insulation element is made of plastic.

8. The non-directional connector as claimed in claim 4, wherein the first conductive element is connected with the third conductive element and the second conductive element is connected with the fourth conductive element by a conductive wire.

9. The non-directional connector as claimed in claim 4, wherein the first conductive element is connected with the third conductive element and the second conductive element is connected with the fourth conductive element by a metallic material.

10. The non-directional connector as claimed in claim 4, wherein the sizes of the holes are larger than those of the positive pole of the battery and are smaller than those of the negative pole of the battery.

11. A non-directional connection device used to connect a plurality of batteries, comprising:
a first non-directional connector, used to connect a first battery and comprising:
a first non-directional connection module, used to connect one of positive and negative pole of the first battery; and
a second non-directional connection module, electrically connecting the first non-directional connection module and used to connect the other of positive and negative pole of the first battery;
a second non-directional connector, electrically connecting the first non-directional connector and used to connect a second battery, comprising:
a third non-directional connection module, used to connect one of positive and negative pole of the second battery; and
a fourth non-directional connection module, electrically connecting the third non-directional connection module and used to connect the other of positive and negative pole of the second battery.

12. The non-directional connection device as claimed in claim 11, wherein the first non-directional connection module includes:
a first conductive element, used to connect the positive pole of the first battery;
a second conductive element, used to connect the negative pole of the first battery and having a first hole so that the positive pole of the first battery passes through the first hole; and
a first insulation element, positioned between the first conductive element and the second conductive element and having a second hole so that the positive pole of the first battery passes through the second hole.

13. The non-directional connection device as claimed in claim 11, wherein the second non-directional connection module includes:
a third conductive element, electrically connecting the first conductive element and used to connect the positive pole of the first battery;
a fourth conductive element, electrically connecting the second conductive element and used to connect the negative pole of the first battery and having a third hole so that the positive pole of the first battery passes through the third hole; and
a second insulation element, positioned between the third conductive element and the fourth conductive element and having a fourth hole so that the positive pole of the first battery passes through the fourth hole.

14. The non-directional connection device as claimed in claim 13, wherein the third non-directional connection module includes:
a fifth conductive element, used to connect the positive pole of the second battery;
a sixth conductive element, used to connect the negative pole of the second battery and having a fifth hole so that the positive pole of the second battery passes through the fifth hole; and
a third insulation element, positioned between the fifth conductive element and the sixth conductive element and having a sixth hole so that the positive pole of the first battery passes through the sixth hole.

15. The non-directional connection device as claimed in claim 14, wherein the fourth non-directional connection module includes:
a seventh conductive element, electrically connecting the fifth conductive element and used to connect the positive pole of the second battery;
a eighth conductive element, electrically connecting the sixth conductive element and used to connect a negative pole of the second battery and having a seventh hole so that the positive pole of the second battery passes through the seventh hole; and
a fourth insulation element, positioned between the seventh conductive element and the eighth conductive element and having an eighth hole so that the positive pole of the second battery passes through the eighth hole.

16. The non-directional connection device as claimed in claim 15, wherein the first non-directional connector is connected with the second non-directional connector by connecting the first conductive element with the sixth conductive element or the eighth conductive element.

17. The non-directional connection device as claimed in claim 15, wherein the first non-directional connector is connected with the second non-directional connector by connecting the third conductive element with the sixth conductive element or the eighth conductive element.

18. The non-directional connection device as claimed in claim 15, wherein the first non-directional connector is connected with the second non-directional connector by connecting the fifth conductive element with the second conductive element or the fourth conductive element.

19. The non-directional connection device as claimed in claim 15, wherein the first non-directional connector is connected with the second non-directional connector by connecting the seventh conductive element with the second conductive element or the fourth conductive element.

20. The non-directional connection device as claimed in claim 15, wherein the sizes of the holes are larger than those of the positive poles of the first and the second batteries and are smaller than those of the negative poles of the first and the second batteries.
